(19) United States
(12) Patent Application Publication
(10) Pub. No.: US 2023/0298799 A1
(43) Pub. Date: Sep. 21, 2023

(54) COIL COMPONENT, CIRCUIT BOARD ARRANGEMENT, ELECTRONIC DEVICE, AND METHOD OF MANUFACTURING COIL COMPONENT

(71) Applicant: TAIYO YUDEN CO., LTD., Tokyo (JP)

(72) Inventors: Yoshiaki KAMIYAMA, Takasaki-shi (JP); Kenichiro NOGI, Takasaki-shi (JP); Kozue IMAIZUMI, Takasaki-shi (JP)

(21) Appl. No.: 18/171,169

(22) Filed: Feb. 17, 2023

(30) Foreign Application Priority Data
Mar. 17, 2022 (JP) 2022-042134

(51) Int. Cl. H01F 27/24; H01F 27/29; H01F 41/02

(52) U.S. Cl. CPC H01F 27/24; H01F 27/292; H01F 41/0246

(57) ABSTRACT

A coil component includes a winding part and a magnetic base body. The winding part is constituted by a wound conductor. The magnetic base body includes a first magnetic portion and a second magnetic portion. The first magnetic portion has first metallic particles bonded together. An average particle diameter of the first metallic particles is a first particle diameter. The second magnetic portion has second metallic particles bonded together. An average particle diameter of the second metallic particles is a second particle diameter. The magnetic base body encapsulates the winding part. The second particle diameter is larger than the first particle diameter. At least a portion of the first magnetic portion is present around the winding part.

### FIELD OF THE INVENTION

This invention relates to coil components, circuit board arrangements, electronic devices, and methods of manufacturing the coil components.

### DESCRIPTION OF THE RELATED ART

Required properties of coil components differ depending on their applications. When magnetic saturation properties are required, a Mn—Zn ferrite material is used as a magnetic material of the coil component. When component size reduction is required, a metallic magnetic material is often used as a magnetic material of the coil component.

One type of coil component that uses a metallic magnetic material is called a metal-composite coil component, in which a composite magnetic material made by mixing Fe-based metallic magnetic particles and resin is used. This type of coil component can achieve size reduction to an external dimension of 2 mm, for example.

Coil components that use metallic magnetic materials are manufactured through a process of pressurizing and hardening a composite magnetic material in which metallic magnetic particles and resin are mixed. Therefore, the filling ratio of metallic magnetic particles is limited due to the presence of resin, the arrangement of metallic magnetic particles, and the degree of deformation of the metallic magnetic particles. For this reason, coil components made of metallic magnetic material have lower relative magnetic permeability obtained as a magnetic body. Thus, use of such coil components is more restricted in their applications than are coil components made of ferrite magnetic material. For example, coil components made of metallic magnetic materials may not be suitable for applications that require high inductance properties.

In coil components that use metallic magnetic materials, there is a need to increase relative magnetic permeability to broaden their applications. One of the methods to increase relative magnetic permeability is to increase the filling ratio of metallic magnetic materials by high pressure.

In order to obtain satisfactory inductance properties in coil components that use metallic magnetic materials, it is effective to increase the projected area (as viewed in an axial direction) of the magnetic material portion (magnetic body) that exists inside the inner circumference of the winding portion of the conductor (winding part of the conductor) because the magnetic material portion that exists inside the inner circumference of the winding portion of the conductor has a large influence.

For example, JP-A-2013-183052 discloses a technique to adjust the size of the magnetic body by polishing, etc., so that the projected area (as viewed in an axial direction) of the magnetic material portion (magnetic body) inside the inner circumference of the coil becomes about the same as the projected area of the magnetic material portion outside the outer circumference of the coil.

### SUMMARY OF THE INVENTION

In recent years, it has become clear that the magnetic body located outside the winding part of the coil is not used effectively when viewed as a whole magnetic body. This is due to the fact that the external shape of a normal magnetic body is rectangular parallelepiped whereas the external shape of the winding part of the coil is circular or oval, and this difference in the external shape causes the magnetic flux to be partially non-uniform. In many cases, the corner portions of the rectangular parallelepiped shape of the magnetic body do not take advantage of the original or inherent magnetic properties.

If the inside of the winding part of the coil is enlarged such that the external shape of the winding part of the coil becomes similar to the external shape of the magnetic body, the length of the conductor that makes the winding part of the coil becomes longer, resulting in higher resistance. In other words, simple enlargement of the winding part of the coil does not improve the performance of the coil component.

This situation seriously influences the properties of the coil component as the coil component requires a higher filling ratio, an increased core area of cross section, and further downsizing. One of the most significant effects is that the magnetic flux becomes non-uniform around the winding part of the coil, resulting in a partial concentration of magnetic flux. As a result, the coil component is prone to magnetic saturation.

One purpose of the present invention is to provide a coil component with good magnetic saturation properties.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a coil component which includes a winding part and a magnetic base body. The winding part has a wound conductor. The magnetic base body includes a first magnetic portion and a second magnetic portion. The first magnetic portion has first metallic particles bonded together. An average particle diameter of the first metallic particles is a first particle diameter. The second magnetic portion has second metallic particles bonded together. An average particle diameter of the second metallic particles is a second particle diameter. The magnetic base body encapsulates the winding part. The second particle diameter is larger than the first particle diameter. At least a portion of the first magnetic portion is present around the winding part.

The first magnetic portion may be provided adjacent to an outer circumference of the winding part.

The first magnetic portion may be provided along an entire outer circumference of the winding part.

The first magnetic portion may occupy at least a half of a volume of the magnetic base body outside the winding part.

The coil component may further include an external electrode, and the first magnetic portion may be provided between the winding part and the external electrode.

An external shape of the coil component may be rectangular parallelepiped, and a long side of the external shape may be 1.0 mm or less.

An external shape of the coil component may be square or rectangular when viewed from a height direction of the coil component. A height dimension of the external shape is smaller than one side of the square or rectangle.

According to another aspect of the present invention, there is provided a circuit board arrangement. The circuit board arrangement includes the above-described coil component, and a board on which the coil component is mounted.

According to still another aspect of the present invention, there is provided an electronic device that includes the circuit board arrangement.

According to yet another aspect of the present invention, there is provided a method of manufacturing the above-described coil component. The method includes, in an arbitrary order: forming a compact of a first magnetic portion; forming a compact of a second magnetic portion; and making a magnetic base body such that a winding part that has a wound conductor is encapsulated by the compact of the first magnetic portion and the compact of the second magnetic portion.

A portion of the magnetic base body outside the winding part may be formed of one kind of material.

A binder that binds the first metal particles together and a binder that binds the second metal particles together may be of the same composition.

Bonding the first metal particles together in the first magnetic portion and bonding the second metal particles together in the second magnetic portion may be performed in a same process.

According to this invention, a coil component with good magnetic saturation properties can be obtained.

### BRIEF DESCRIPTION OF THE DRAWINGS

FIG. 1 is a perspective view of a coil component of one embodiment of the present invention.

FIG. 2A is a cross-sectional view of the coil component shown in FIG. 1, taken along the line 2A-2A in FIG. 1.

FIG. 2B is a cross-sectional view of the coil component shown in FIG. 2A, taken along the line 2B-2B in FIG. 2A.

FIG. 3 is a perspective view of a coil component that has a modified configuration.

FIG. 4 shows a cross-sectional view of the magnetic base body in the coil component shown in FIG. 1.

FIG. 5 is a schematic enlarged view of the microscopic structure of the first magnetic portion.

FIG. 6 is a schematic enlarged view of the microscopic structure of the second magnetic portion.

FIG. 7A shows a first step of a method of manufacturing the coil component in the first embodiment.

FIG. 7B is a cross-sectional view of FIG. 7A, taken along the line 7B-7B in FIG. 7A.

FIG. 8 is a schematically enlarged view of a certain region in FIG. 7A.

FIG. 9A shows a second step of the method of manufacturing the coil component.

FIG. 9B is a cross-sectional view of FIG. 9A, taken along the line 9B-9B in FIG. 9A.

FIG. 10A shows a third step of the method of manufacturing the coil component.

FIG. 10B is a cross-sectional view of FIG. 10A, taken along the line 10B-10B in FIG. 10A.

FIG. 11 is a schematically enlarged view of a certain region in FIG. 10B.

FIG. 12 shows a fourth step of the method of manufacturing the coil component.

FIG. 13A shows a first step of a method of manufacturing a coil component in a second embodiment of the present invention.

FIG. 13B is a cross-sectional view of FIG. 13A, taken along the line 13B-13B in FIG. 13A.

FIG. 14A shows a second step of the method of manufacturing the coil component in the second embodiment.

FIG. 14B is a cross-sectional view of FIG. 14A, taken along the line 14B-14B in FIG. 14A.

FIG. 15A shows a third step of the method of manufacturing the coil component in the second embodiment.

FIG. 15B is a cross-sectional view of FIG. 15A, taken along the line 15B-15B in FIG. 15A.

FIG. 16 shows a fourth step of the method of manufacturing the coil component in the second embodiment.

FIG. 17A shows a first step of a method of manufacturing a coil component in a third embodiment of the present invention.

FIG. 17B is a cross-sectional view of FIG. 17A, taken along the line 17B-17B in FIG. 17A.

FIG. 18A shows a second step of the method of manufacturing the coil component in the third embodiment.

FIG. 18B is a cross-sectional view of FIG. 18A, taken along the line 18B-18B in FIG. 18A.

FIG. 19A shows a third step of the method of manufacturing the coil component in the third embodiment.

FIG. 19B is a cross-sectional view of FIG. 19A, taken along the line 19B-19B in FIG. 19A.

FIG. 20 shows a fourth step of the method of manufacturing the coil component in the third embodiment.

FIG. 21A shows a first step of a method of manufacturing a coil component in a fourth embodiment of the present invention.

FIG. 21B is a cross-sectional view of FIG. 21A, taken along the line 21B-21B in FIG. 21A.

FIG. 22A shows a second step of the method of manufacturing the coil component in the fourth embodiment.

FIG. 22B is a cross-sectional view of FIG. 22A, taken along the line 22B-22B in FIG. 22A.

FIG. 23A shows a third step of the method of manufacturing the coil component in the fourth embodiment.

FIG. 23B is a cross-sectional view of FIG. 23A, taken along the line 23B-23B in FIG. 23A.

FIG. 24A shows a first step of a method of manufacturing a coil component in a fifth embodiment of the present invention.

FIG. 24B is a cross-sectional view of FIG. 24A, taken along the line 24B-24B in FIG. 24A.

FIG. 25A shows a second step of the method of manufacturing the coil component in the fifth embodiment.

FIG. 25B is a cross-sectional view of FIG. 25A, taken along the line 25B-25B in FIG. 25A.

FIG. 26A shows a third step of the method of manufacturing the coil component in the fifth embodiment.

FIG. 26B is a cross-sectional view of FIG. 26A, taken along the line 26B-26B in FIG. 26A.

FIG. 27A shows a first step of a method of manufacturing a coil component in a sixth embodiment of the present invention.

FIG. 27B is a cross-sectional view of FIG. 27A, taken along the line 27B-27B in FIG. 27A.

FIG. 28A shows a second step of the method of manufacturing the coil component in the sixth embodiment.

FIG. 28B is a cross-sectional view of FIG. 28A, taken along the line 28B-28B in FIG. 28A.

FIG. 29A shows a third step of the method of manufacturing the coil component in the sixth embodiment.

FIG. 29B is a cross-sectional view of FIG. 29A, taken along the line 29B-29B in FIG. 29A.

FIG. 30 shows a fourth step of the method of manufacturing the coil component in the sixth embodiment.

FIG. 31A shows a first step of a method of manufacturing a coil component in a seventh embodiment of the present invention.

FIG. 31B is a cross-sectional view of FIG. 31A, taken along the line 31B-31B in FIG. 31A.

FIG. 32A shows a second step of the method of manufacturing the coil component in the seventh embodiment.

FIG. 32B is a cross-sectional view of FIG. 32A, taken along the line 32B-32B in FIG. 32A.

FIG. 33A shows a third step of the method of manufacturing the coil component in the seventh embodiment.

FIG. 33B is a cross-sectional view of FIG. 33A, taken along the line 33B-33B in FIG. 33A.

FIG. 34A shows a fourth step of the method of manufacturing the coil component in the seventh embodiment.

FIG. 34B is a cross-sectional view of FIG. 34A, taken along the line 34B-34B in FIG. 34A.

FIG. 35 shows a fifth step of the method of manufacturing the coil component in the seventh embodiment.

FIG. 36 shows a sixth step of the method of manufacturing the coil component in the seventh embodiment.

FIG. 37 shows a seventh step of the method of manufacturing the coil component in the seventh embodiment.

FIG. 38 shows an external electrode that has a modified configuration.

### DETAILED DESCRIPTION OF EMBODIMENTS

The following is a detailed description of embodiments of the invention with reference to the accompanying drawings. The following embodiments are not intended to limit the invention, and not all of the combinations of features described in the embodiments are essential for the configuration of the invention. The configuration of the embodiments may be modified or changed if necessary depending on the specifications of the device to which the invention is applied and various conditions (conditions of use, environment of use, etc.).

The technical scope of the invention is defined by the claims and is not limited by the following individual embodiments. The drawings used in the following description may differ in scale and shape from the actual structure in order to make each configuration easier to understand. The components shown in one of the drawings may be referred to as appropriate in the description of other drawings.

Structure of Coil Component

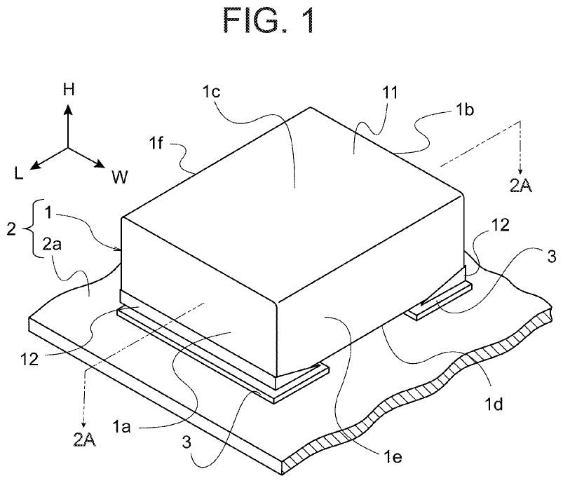

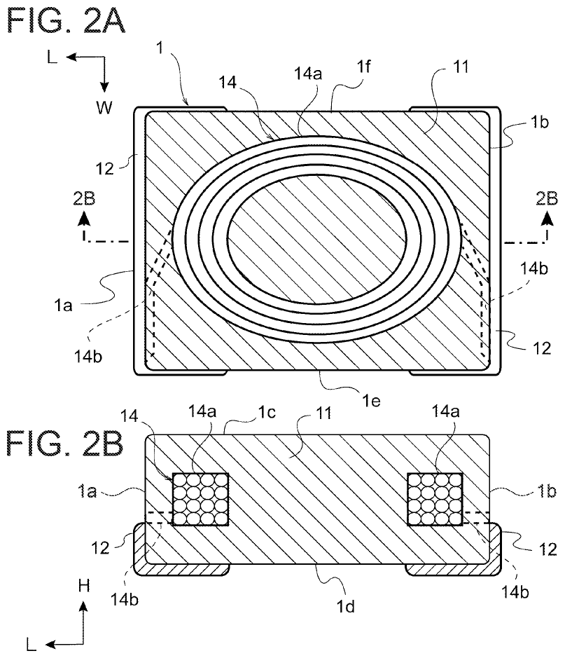

FIG. 1 is a perspective view of a coil component 1. FIG. 2A is a cross-sectional view of the coil component 1, taken along the line 2A-2A in FIG. 1. FIG. 2B is a cross-sectional view of the coil component 1, taken along the line 2B-2B in FIG. 2A.

The coil component 1 is mounted on a substrate 2a. The substrate 2a has, for example, two land portions 3. The coil component 1 has one magnetic base body (element body) 11 and two external electrodes 12. The coil component 1 is mounted on the substrate 2a by soldering the two external electrodes 12 to the two land portions 3, respectively. A circuit board 2 according to this embodiment includes the component 1 and a substrate 2a on which the coil component 1 is mounted. The circuit board 2 may be provided in various electronic devices. Electronic devices equipped with the circuit board 2 include, for example, automotive electrical components, servers, board computers, and various other electronic devices.

The coil component 1 may be an inductor, transformer, filter, reactor, or various other coil components. Alternatively, the coil component 1 may be a coupled inductor, choke coil, or various other magnetically coupled coil components. Alternatively, the coil component 1 may be, for example, an inductor used in a DC/DC converter. Applications of the coil component 1 are not limited to those explicitly mentioned in this specification.

In this specification, unless the context requires otherwise, the description of direction is based on the “L-axis”, “W-axis”, and “H-axis” directions in FIG. 1. The L-axis is referred to as the length direction, the W-axis is referred to as the width direction, and the H-axis is referred to as the height direction. The height direction may also be referred to as the thickness direction.

The external shape of the coil component 1 is rectangular parallelepiped. That is, the coil component 1 has a first end face (left face) 1a and a second end face (right face) 1b at opposite ends in the length direction, a first main face (top face) 1c and a second main face (bottom face) 1d at opposite ends in the height direction, and a front face le and a rear face 1f at opposite ends in the width direction.

The first end face 1a, second end face 1b, first main face 1c, second main face 1d, front face 1e, and rear face lf of the coil component 1 may all be flat, planar, or curved. The rectangular parallelepiped shape of the coil component 1 has eight corners, and twelve ridges that connect the eight corners respectively. The eight corners and twelve ridges of the coil component 1 may be rounded.

It should be noted a part of the first end face 1a, second end face 1b, first main face 1c, second main face 1d, front face 1e, and rear face 1f of the coil component 1 may be curved and/or the corners and ridges of the coil component 1 may be rounded, but such a shape is also referred to as a rectangular parallelepiped shape in this specification. In other words, when “rectangular parallelepiped” and “rectangular” are used herein, they do not mean rectangular parallelepiped and rectangular in the strict mathematical sense.

As shown in FIG. 2A, the coil component 1 of this embodiment has a base body 11, and a conductor 14 inside the base body 11. The base body 11 is a magnetic base body in this embodiment. The conductor 14 has a winding part 14a inside the magnetic base body 11, and two lead portions 14b extending from the winding part 14a. The two lead portions 14b are connected to the two external electrodes 12, respectively.

The conductor 14 includes a metal wire, such as Ag wire or Cu wire, and an insulating film on the surface of the metal wire. Alternatively, the conductor 14 includes a metal wire, which is formed by plating, and an insulating film on the surface of the metal wire. For example, the number of turns in the winding part 14a of the conductor 14 is one or more turns. When the lead portions 14b are situated at opposite positions near the winding part 14a, the number of turns in the winding part 14a may include a fraction and therefore the number of turns can be, for example, 1.5 turns or 2.5 turns.

In the configuration shown in FIG. 2A, the winding part 14a has a generally oval shape when viewed from above. As understood from FIG. 2B, the oval shape of the winding part 14a is parallel to the top face 1c and bottom face 1d of the coil component 1. Thus, the conductor 14 (or the winding part 14a) has a so-called horizontal winding structure (a horizontally-aligned winding structure with a vertical winding axis).

As shown in FIG. 2B, each of the external electrodes 12 is, for example, a so-called L-shaped electrode. The left external electrode 12 extends from the left end area of the bottom surface 1d to the first end face (left face) la of the coil component 1. The right external electrode 12 extends from the right end area of the bottom surface 1d to the second end face (right face) 1b of the coil component 1.

Each of the external electrodes 12 is formed by metals such as Ag, Cu, Ti, Ni, and Sn, for example, with a thickness of 1 μm to 5 μm. Alternatively, each of the external electrodes 12 may be formed by a combination of multiple metal layers, with the total thickness of the combination being 5 μm to 10 μm, for example. The multiple metal layers may be made from different materials. Alternatively, each of the external electrodes 12 may be formed by a combination of metal layers, one or some of which contain resin, with the total thickness of the combination being 10 μm to 20 μm, for example.

The magnetic base body 11 is formed by metal particles containing Fe, Ni, or Co. In addition to the metallic particles, the magnetic base body 11 may also contain resins, metal oxides, and/or ceramic materials. The metallic particles contained in the magnetic base body 11 have soft magnetic properties and may be referred to as metallic magnetic particles. In addition to Fe, Ni, or Co, the metallic particles may further contain one of Si, Cr, Al, B, and P, or contain a plurality of Si, Cr, Al, B, and P. The magnetic base body 11 may be formed from a combination of multiple types of metal particles.

The metal particles contained in the magnetic base body 11 may be spherical or nearly spherical in shape although the shape is not limited to spherical or nearly spherical. The particles are, for example, 1 μm to 60 μm in size (diameter) and have some particle size distribution. The metallic particles may have undergone an insulation treatment before the metallic particles are contained in the base body 11. If the magnetic base body 11 contains other particles such as metal particles, metal oxide particles, or ceramic material particles with even smaller particle sizes, the size of these particles is 0.01 μm to 1 μm. When the magnetic base body 11 contains these particles (metal particles, metal oxide particles, or ceramic material particles), these particles contribute to reducing voids or increasing mechanical strength, for example, rather than enhancing the magnetic property.

The metal particles contained in the magnetic base body 11 are bound by a binder, such as a resin, metal oxide, or ceramic material. The magnetic base body 11 contains 85 vol % or more of metal particles, and may even contain 88 vol % or more, with the remainder being an insulating material.

The magnetic base body 11 may be a compacted powder in which metal particles are bonded to each other without a binder. The material of the magnetic base body 11 is not limited to those explicitly specified in this specification, and any suitable material known as a material for magnetic element bodies may be used.

When viewed from the height direction H, each side of the external shape (rectangular shape) of the coil component 1 is 4.0 mm or less, 2.0 mm or less, or even 1.0 mm or less. The height of the coil component 1 is 1.0 mm or less, 0.65 mm or less, or even 0.5 mm or less. The external shape of the coil component 1 viewed from the height direction H (i.e., the top face 1c) may be square although FIG. 1 shows a rectangular shape. The height of the coil component 1 may be smaller than one side of the top face 1c of the coil component 1. The long side of the rectangular shape of the top face 1c, viewed from the height direction H, is 3.0 mm or less, and even 1.0 mm or less.

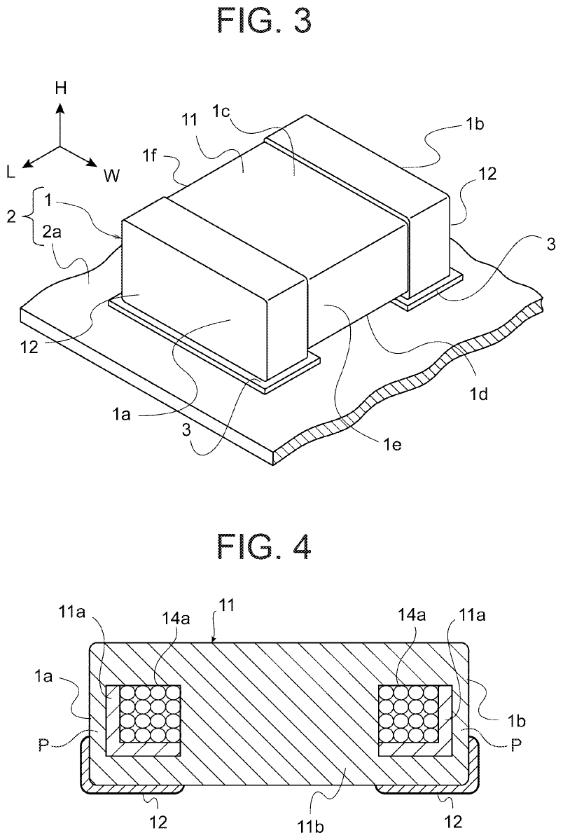

A modification to the coil component 1 will be described with reference to FIG. 3.

As shown in FIG. 3, the shape of each of the external electrodes 12 of the coil component 1 in FIG. 3 is different from the shape of each of the external electrodes 12 of the coil component 1 in FIG. 1. In FIG. 3, the left external electrode 12 of the coil component 1 generally covers the left face 1a of the coil component 1, and the right external electrode 12 generally covers the right face 1b of the coil component 1. It should be noted that the inner structure of the coil component 1 (e.g., the conductor 14 and the winding part 14a) is not shown in FIG. 3, but the reference numerals used in FIGS. 1 to 2B are used in the following description of FIG. 3.

In the configuration shown in FIG. 3, each of the external electrodes 12 has five surfaces. Specifically, one surface of the left external electrode 12 is present on the left face 1a and the remaining four surfaces extend from the left face 1a to a neighboring area of the top face 1c, bottom face 1d, front face 1e, and rear face 1f, respectively. One surface of the right external electrode 12 is present on the right face 1b and the remaining four surfaces extend from the right face 1b to a neighboring area of the top face 1c, bottom face 1d, front face 1e, and rear face 1f, respectively. The coil component 1 is mounted on the substrate 2a by soldering the two external electrodes 12 to the two land portions 3, respectively. The circuit board 2 includes the coil component 1, and the substrate 2a on which the coil component 1 is mounted.

The coil component 1 of FIG. 3 has the conductor 14 inside the magnetic base body 11. The conductor 14 has a so-called vertical winding structure (a vertically-aligned winding structure with a vertical winding axis), which is parallel to the first end face la and the second end face 1b of the coil component 1.

The contribution of each part of the magnetic base body 11 to the magnetic properties of the coil component 1 is mainly determined by its positional relationship to the winding part 14a of the conductor 14. In other words, the parts of the magnetic base body 11 may be distinguished by their contribution to the magnetic properties, e.g., the inner portion surrounded by the winding part 14a and the outer portion around the winding part 14a. This contribution is the same regardless of whether the conductor 14 has a horizontal winding structure or a vertical winding structure, i.e., the contribution to the magnetic properties when the conductor 14 has a horizontal winding structure is the same as the contribution to the magnetic properties when the conductor 14 has a vertical winding structure. For this reason, the following description will deal with the coil component 1 that has the horizontal winding structure shown in FIGS. 1 to 2B.

Structure of Magnetic Base Body

FIG. 4 is a cross-sectional view of the magnetic base body 11 in the coil component 1 shown in FIGS. 1, 2A, and 2B. FIG. 4 is similar to FIG. 2B, and the illustration focuses on the detailed structure of the magnetic base body 11.

The magnetic base body 11 includes a first magnetic portion 11a and a second magnetic portion 11b, which enclose the winding part 14a. In the configuration shown in FIG. 4, the first magnetic portion 11a is provided around the outer circumference of the winding part 14a, and the second magnetic portion 11b occupies the remaining part of the base body 11.

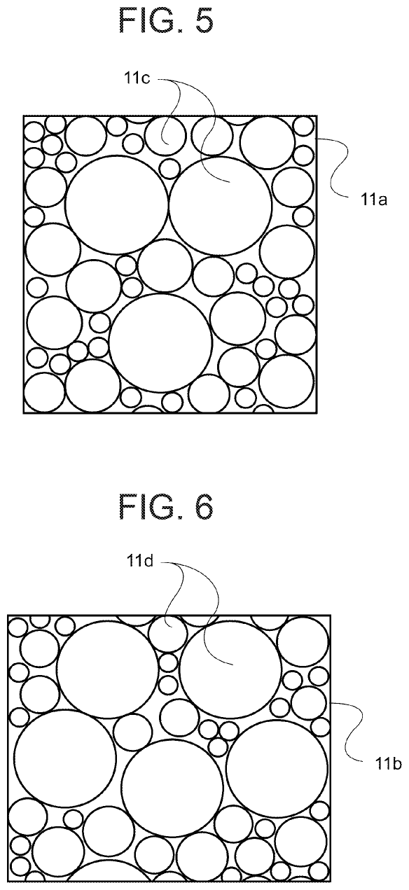

FIG. 5 is a schematic enlarged view of the microscopic structure of the first magnetic portion 11a, and FIG. 6 is a schematic enlarged view of the microscopic structure of the second magnetic portion 11b.

The first magnetic portion 11a has a structure in which the first metallic particles 11c are bonded together. The first metallic particles 11c have a particle size distribution, and the average particle diameter in the particle size distribution is 1 μm to 10 μm. The average particle size in the first metallic particle 11c is hereinafter referred to as the first particle size.

The second magnetic portion 11b has a structure in which the second metal particles 11d are bonded together. The second metal particles 11d have a particle size distribution, and the average particle diameter in the particle size distribution is 5 μm to 20 μm. The average particle size in the second metal particles 11d is hereinafter referred to as the second particle size.

The second grain size is larger than the first grain size. Thus, the first magnetic portion 11a has higher magnetic saturation properties than the second magnetic portion 11b, and the second magnetic portion 11b has higher relative magnetic permeability than the first magnetic portion 11a.

The average particle diameter of the metal particles is determined (obtained), for example, by a laser diffraction particle size analyzer (particle distribution measuring device). Alternatively, the average particle diameter of the metal particles may be determined by a calculation from the measurement results. Specifically, a cross section of the magnetic base body 11 is observed with an optical microscope, for example, particles larger than 1 μm in size are measured, and the calculation is carried out with the measurement results to obtain the average particle diameter of the metal particles.

As shown in FIG. 4, the magnetic saturation properties of the coil component 1 are improved when the first magnetic portion 11a is provided around the winding part 14a. The improvement of the magnetic saturation properties enables the area of the magnetic base body 11 outside the winding part 14a to be reduced when viewed in the direction of the coil axis of the winding part 14a (when viewed in the height direction). This in turn enables the coil component 1 to be made smaller. In addition, because the magnetic base body 11 has both the first magnetic portion 11a and the second magnetic portion 11b, the magnetic saturation property is improved and the high relative magnetic permeability is maintained, thereby improving the performance of the coil component 1. In other words, since the performance of the coil component 1 is ensured, the coil component 1 can be downsized. The first magnetic portion 11a need only be provided at least partly around the winding part 14a, and other parts of the first magnetic portion 11a may be provided inside the winding part 14a.

Preferably, the first magnetic portion 11a is provided next to the outer circumference of the winding part 14a as shown in FIG. 4. Here, the outer circumference of the winding part 14a means that it is outside of the winding part 14a within the upper and lower ranges that appear to overlap the winding part 14a when viewed from the inside of the winding part 14a.

“Next to” may be “adjacent to” and means that there is no other magnetic material between the winding part 14a and the first magnetic portion 11a. Specifically, “next to” includes a case where the winding part 14a and the first magnetic portion 11a directly contact each other and a case where the winding part 14a and the first magnetic portion 11a contact each other via an insulator. The magnetic saturation characteristic of the coil component 1 is improved because the first magnetic portion 11a is provided at the location next to (adjacent to) the outer circumference of the winding part 14a. This is because the location next to (adjacent to) the outer circumference of the winding part 14a is a location where the magnetic flux can easily pass through.

Preferably, the first magnetic portion 11a is provided along the entire outer circumference of the winding part 14a. In other words, it is preferred that the first magnetic portion 11a is provided over the entire outer circumference of the winding part 14a when viewed from the inner circumference to the outer circumference of the winding part 14a. Thus, it is preferred that the first magnetic portion 11 a extends around the entire outer circumference of the winding part 14a. By providing the first magnetic portion 11a along the entire outer circumference of the winding part 14a, the magnetic saturation properties are maintained at all positions along the entire outer circumference of the winding part 14a, which further improves the magnetic saturation properties of the coil component 1.

Around the outer circumference of the winding part 14a, the ratio of the first magnetic portion 11a to the base body 11 is preferably half or more than half. Here, the ratio being “half or more than half” corresponds, for example, to a case where the volume of the first magnetic portion 11a is equal to or more than 50% with the volume of the base body 11 around on the winding part 14a being 100%. The magnetic saturation characteristic of the coil component 1 is maintained as the proportion of the first magnetic part 11a is half or more.

For the portion of the magnetic base body 11 around the outer circumference of the winding part 14a, it is preferred that the first magnetic portion 11a is provided between the winding part 14a and the external electrode 12 because the insulation between the winding part 14a and the external electrode 12 is enhanced. To be provided between the winding part 14a and the external electrode 12 means that the first magnetic portion 11a is present between each portion of the external electrode 12 and the winding part 14a connected by the shortest possible distance. For example, when the external electrodes 12 are provided on the end faces 1a, 1b, a particular region may be defined by lines connecting the entire outer circumference of each of the external electrodes 12 to the winding part 14a at the shortest distance. Then, the first magnetic portion 11a is present over the entire winding part 14a within this region.

Of the portions of the magnetic base body 11 located around the winding part 14a, the portion with the thinnest thickness in the direction of proximity-divergence with respect to the winding part 14a (for example, the portion P shown in FIG. 4) is the portion that most affects the magnetic properties in the coil component 1. For this reason, it is preferred that the arrangement of the first magnetic portion 11a be realized especially at the portion P where the thickness of the magnetic base body 11 is thinnest. The thinnest part P of the magnetic base body 11 is, for example, 0.1 mm or less in thickness, and even 0.05 mm or less in thickness.

In addition to the first magnetic portion 11a and the second magnetic portion 11b, the magnetic base body 11 may have a third magnetic portion. The magnetic material of the third magnetic portion may be of the same composition as the first magnetic portion 11a, or the same composition as the second magnetic portion 11b. Alternatively, the magnetic material of the third magnetic portion may be of a different composition from both the first and second magnetic portions 11a and 11b.

Method of Manufacturing Coil Component

A method of manufacturing the coil component 1 will be described below, focusing on a process of making the magnetic base body 11.

The magnetic base body 11 is made from a composite material for the first magnetic portion 11a and another composite material for the second magnetic portion 11b. Each composite material includes a mixture of the metal particles and resin. The metal particles and resin will ultimately become the first magnetic portion 11a and the second magnetic portion 11b. The two composite materials undergo compression molding or warm molding to obtain a compact, and the compact is the base body 11.

Hereinafter, formation by compression molding or warm molding is simply referred to as “molding”. The pressure during the molding of the magnetic base body 11 is between 10 MPa and 1 GPa, and the temperature of the molding is between 10 degrees C. and 200 degrees C.

Molding in the manufacture of the magnetic base body 11 may combine both pressurizing and heating. The combination of pressurizing and heating allows the molding to be carried out at relatively low pressures of 10 MPa to 100 MPa. Molding methods in which pressurizing and heating are combined include, for example, sheet molding and transfer molding.

In the molding during the manufacture of the magnetic base body 11, the composite materials for the first and second magnetic portions 11a and 11b are prepared, for example, by using a technique of particle size blending in which multiple types of metal particles with different particle sizes are combined, so that the first and second magnetic portions 11a and 11b with desired particle sizes are ultimately obtained. That is, a first composite material containing first metal particles 11c with an average particle diameter of the first particle diameter and a second composite material containing second metal particles 11d with an average particle diameter of the second particle diameter are each prepared by particle size blending. The first composite material is used for molding the first magnetic portion 11a, and the second composite material is used for molding the second magnetic portion 11b. In molding the first composite material and the second composite material, it is preferred that a binding material (binder) such as resin be the same component. Use of the same composition of the binding material (binder) ensures that the first magnetic portion 11a and the second magnetic portion 11b are combined and joined together more reliably than if the components of the binding material were different.

Alternatively, the molding of the magnetic base body 11 may use a technique of flow control that can adjust the molding thickness and the size of the metal particles, for example. Such molding can also ensure that the first magnetic portion 11a and the second magnetic portion 11b will have the desired particle diameters. That is, since the flow of metal particles with larger particle diameters is restricted in areas with smaller molding thicknesses during molding, only some of the metal particles contained in the areas with the smaller molding thicknesses can have large particle diameters. Specifically, the first magnetic portion 11a is molded with a thickness less than three times the average particle diameter of the metal particles contained in the composite material, and the second magnetic portion 11b is molded with a thickness more than three times the average particle diameter.

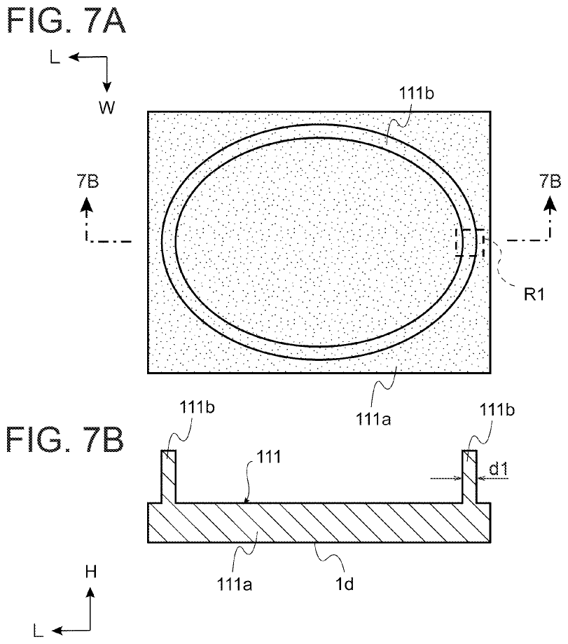

Details of the method of manufacturing the coil component 1 will now be described with reference to FIG. 7A to FIG. 12.

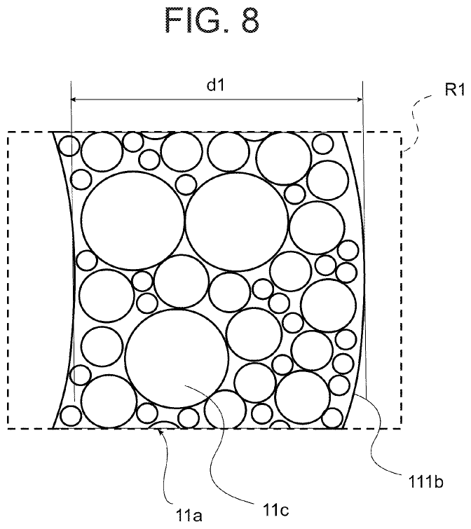

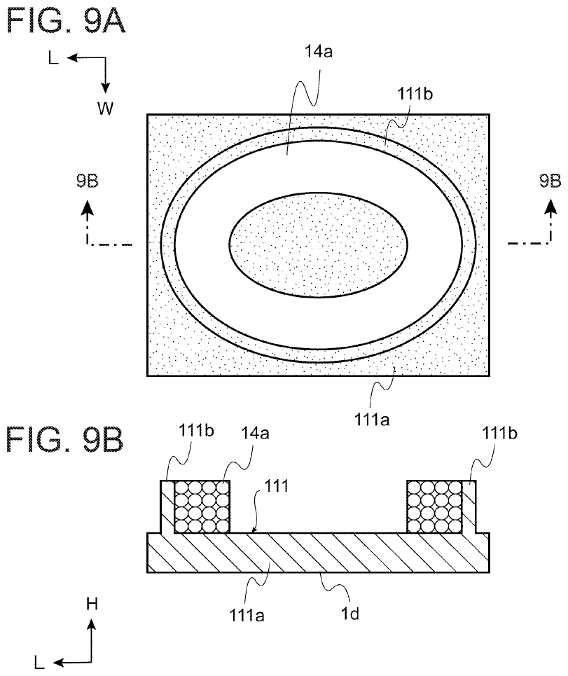

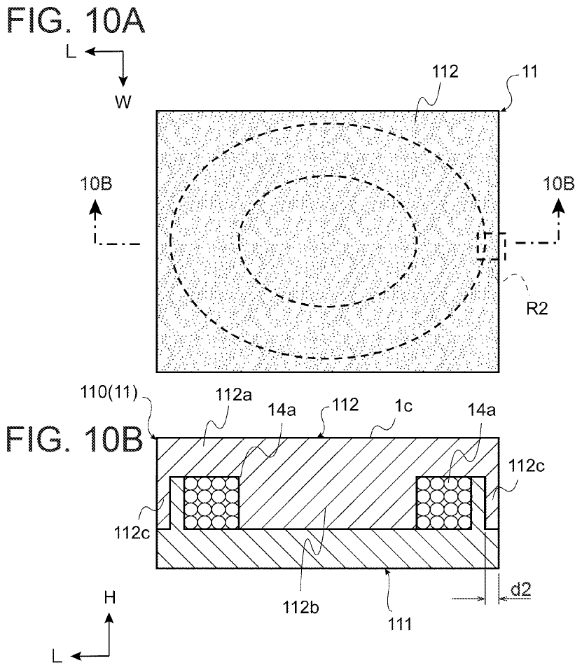

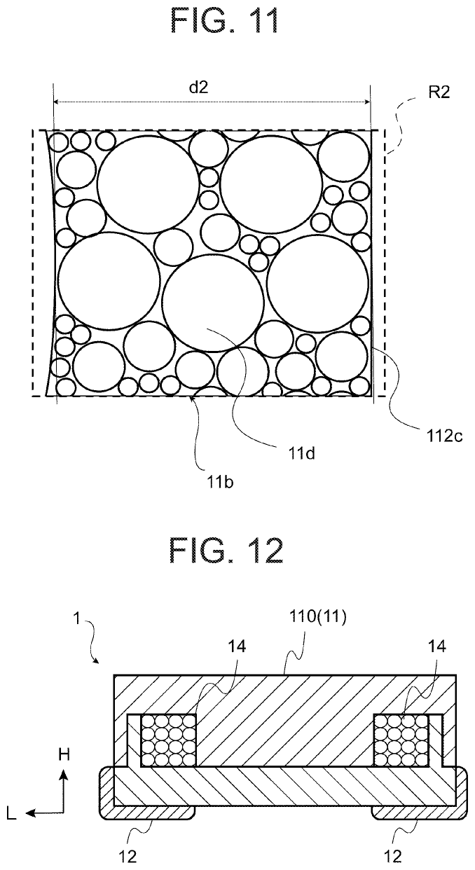

FIG. 7A is a top view. FIG. 7B is a cross-sectional view taken along the line 7B-7B in FIG. 7A. FIG. 8 shows a schematically enlarged view of the region R1 (the rectangular region surrounded by the broken line) shown in FIG. 7A. FIG. 9A is a top view. FIG. 9B is a cross-sectional view taken along the line 9B-9B in FIG. 9A. FIG. 10A is a top view. FIG. 10B is a cross-sectional view taken along the line 10B-10B in FIG. 10A. FIG. 11 shows a schematically enlarged view of the region R2 (the rectangular region surrounded by the broken line) shown in FIG. 10A. FIG. 12 shows a cross-sectional view corresponding to the cross-sectional view shown in FIG. 2B.

In this method of manufacturing the coil component 1, the magnetic base body 11 is divided into a bottom part 111, which includes the bottom face 1d of the coil component 1, and an upper part 112, which includes the top face 1c of the coil component 1.

For example, as shown in FIGS. 7A and 7B, the bottom part 111 is formed first. The bottom part 111 has a bottom plate 111a that defines the bottom face 1d of the coil component 1 and a protruding portion 111b that protrudes in an oval shape from the bottom plate 111a toward the top face 1c of the coil component 1. The oval shape of the protruding portion 111b is designed such that the winding part 14a of the conductor 14 just fits in the oval shape.

The bottom part 111 is formed by filling the above-mentioned composite material into a mold that corresponds to the shape of the bottom plate 111a and the protruding portion 111b. For example, when the bottom part 111 is molded by the flow control method, the metal particles in the composite material are second metal particles 11d with an average particle diameter being the second particle diameter, and the bottom plate portion 111a is formed from a combination of the second magnetic portion 11b and the second metal particles 11d (i.e., the second magnetic portion 11b to which the second metal particles 11d are bound).

On the other hand, the thickness d1 of the protrusion 111b (FIG. 8) is less than three times the second particle diameter, which restricts the flow of the larger diameter particles of the second metal particles 11d. In other words, small metal particles can flow into the portion of the mold corresponding to the protrusion 111b of thickness d1 without restriction, while large metal particles are restricted from flowing into that portion of the mold. As a result, the particle size distribution of the metal particles of the protrusion 111b changes from that of the second metal particles 11d, and the protrusion 111b becomes the first magnetic portion 11a to which the first metal particles 11c of the first particle diameter whose average particle diameter is smaller than the second particle diameter are bound.

When molding the bottom part 111, the bonding of the metal particles in the first magnetic portion 11a and the bonding of the metal particles in the second magnetic portion 11b take place in the same process (e.g., pressurization process). As a result, the first magnetic portion 11a and the second magnetic portion 11b are securely bonded together.

In the process of molding the bottom part 111, the first metallic particles 11c and second metallic particles 11d may be bonded by heat treatment. The bonding of the metal particles by heat treatment increases the strength of the bottom part 111 and enhances the bonding between the bottom plate 111a and the protruding portion 111b (i.e., the bonding between the first magnetic portion 11a and the second magnetic portion 11b).

The conductor 14 is placed inside the oval-shaped protrusion 111b of the molded bottom part 111, as shown in FIGS. 9A and 9B. For convenience, only the winding part 14a may be shown to represent the conductor 14. Upon placing the conductor 14 in the oval protrusion 111b as shown in FIGS. 9A and 9B, the protrusion 111b contacts the outer circumference of the winding part 14a and surrounds the entire circumference of the winding part 14a.

Subsequently, as shown in FIGS. 10A and 10B, the top part 112 is molded over the bottom part 111 and the conductor 14 to obtain a compact 110. The conductor 14 becomes an integrated portion of the compact 110. The compact 110 becomes the magnetic base body 11. The upper part 112 has a top plate portion 112a, a core portion 112b, and an outer edge portion 112c. The top plate portion 112a defines the top surface 1c of the coil component 1. The core portion 112b projects downward from a center area of the top plate portion 112a toward the bottom surface 1d of the coil component 1. The outer edge portion 112c projects downward from an edge area of the top plate portion 112a toward the bottom surface 1d. The core portion 112b is present inside the winding part 14a. The outer edge portion 112c is present outside the winding part 14a and the upward protrusion 111b of the bottom part 111.

For example, a mold having the shape of the top face 1c side of the upper part 112 is placed over the bottom part 111 and conductor 14, and the mold is filled with the composite material to form the upper part 112. In the molding process of the upper part 112, no particular thickness limit is set, and the molding is performed with a sufficient thickness that is at least three times thicker than the second particle diameter. That is, even for the thinnest region R2 of the upper part 112, the thickness d2 (smallest thickness of the downward protrusion 112c in the L-axis direction) is at least three times the second particle diameter. Therefore, as shown in FIG. 11, the entire upper part 112, including the thinnest portion of the outer edge 112c, becomes the second magnetic portion 11b to which the second metal particles 11d are bound.

Thus, the magnetic base body 11 that contains the first magnetic portion 11a and the second magnetic portion 11b is molded from the same composite material (i.e., single kind of material), which minimizes the type of metal particles used in the composite material and contributes to cost reduction in the manufacture of the coil component 1.

In the above-described exemplary manufacturing method, the bottom part 111 and top part 112 are molded from the same composite material, but the bottom part 111 and top part 112 may be molded from different composite materials. For example, the bottom part 111 may be molded from a composite material containing the first metal particle 11c and the top part 112 may be molded from a composite material containing the second metal particle 11d. In this case, the entire bottom part 111 becomes the first magnetic portion 11a and the top part 112 becomes the second magnetic portion 11b.

In this case, the first magnetic portion 11a may be molded thicker than the second magnetic portion 11b outside the winding part 14a, and the first magnetic portion 11a may occupy a half (or more than a half) the thickness of the magnetic base body 11 outside the winding part 14a.

Further heat treatment may be applied to the compact 110, which has the conductor 14 therein and will serve as the magnetic base body 11. The heat treatment strengthens the bond between the bottom part 111 and the top part 112, and enhances integrity between the conductor 14 and the magnetic base body 11.

After the magnetic base body 11 that has the conductor 14 therein is obtained, the outer electrodes 12 are formed on the outer surface of the magnetic base body 11 to obtain the coil component 1, as shown in FIG. 12. Each of the external electrodes 12 is made of the above-mentioned materials such as Ag, Cu, etc., and is formed on the surface of the magnetic base body 11 by printing paste, forming a film by sputtering or plating, or bonding metal foil. It should be noted that a portion of the external electrode 12 may be provided prior to applying the heat treatment to the magnetic base body 11.

According to the manufacturing process shown in FIG. 7A through FIG. 12, the magnetic base body 11 having the first magnetic portion 11a and the second magnetic portion 11b is obtained by molding, and integration with the conductor 14 is also realized by molding. Therefore, integration is realized without any additional processes such as assembly.

For the compact 110 of the magnetic base body 11, additional heat treatment may be applied to further increase mechanical strength.

Machining may be applied to any part of the magnetic base body 11, conductor 14, and external electrodes 12 after molding. For example, a portion of each of the leads 14b of the conductor 14 (or its vicinity of the base body 11) may be machined to expose the lead 14b from the surface of the base body 11. Also, the surface of the base body 11 may be machined to create areas (e.g., shallow concave areas) to receive the external electrodes 12. In view of the manufacturing process shown in FIG. 7A to FIG. 12, a skilled artisan in the art can readily modify the arrangement, dimensions, etc. of the first magnetic portion 11a and the second magnetic portion 11b according to the intended use, the intended properties, etc., as a matter of routine experimentation.

### Other embodiments

The following is an explanation of other embodiments of the coil component 1, focusing on the differences from the manufacturing method shown in FIG. 7A through FIG. 12.

### Second Embodiment

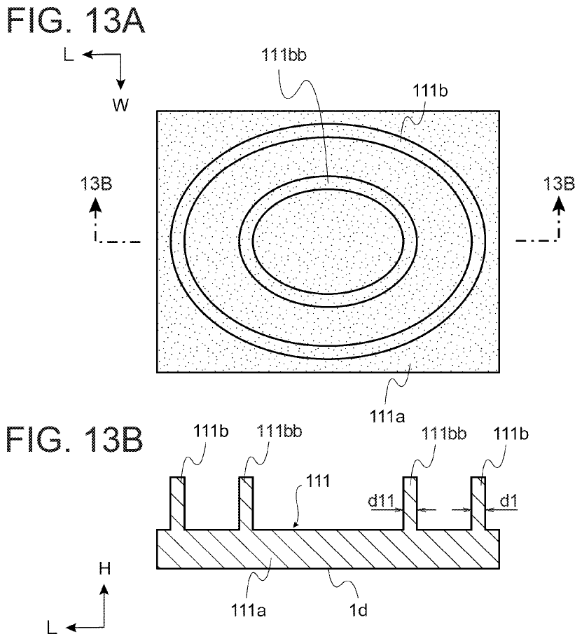

FIG. 13A to FIG. 16 show the manufacturing method of the coil component 1 in a second embodiment of the present invention. Similar reference numerals are used to designate similar items in the first and second embodiments.

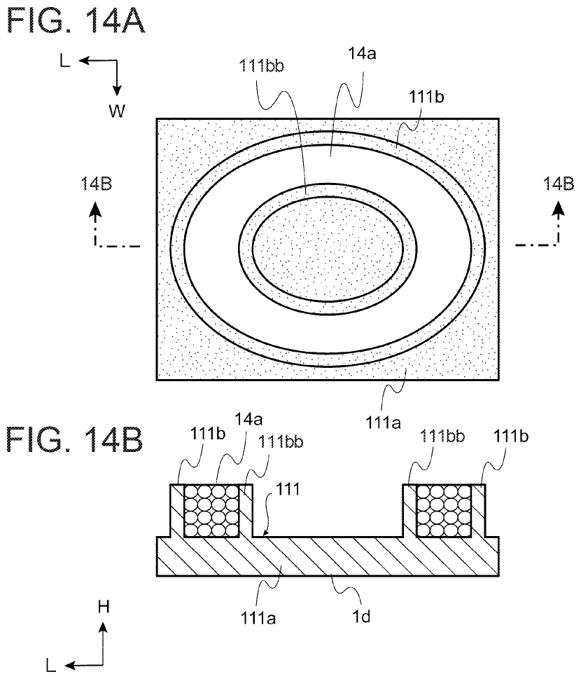

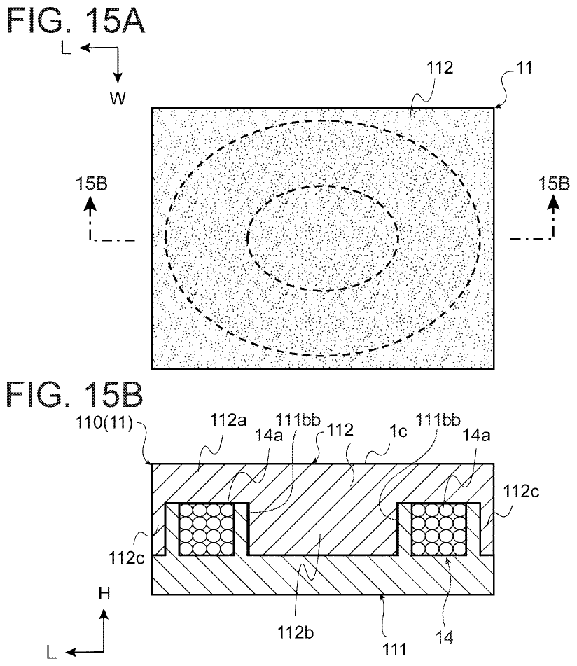

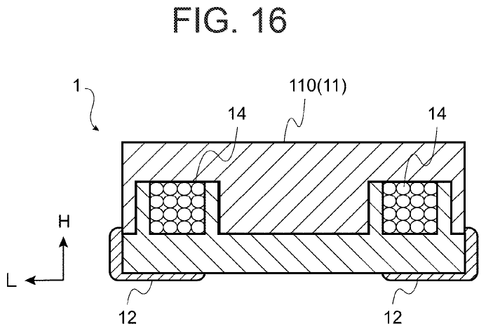

FIG. 13A is a top view and FIG. 13B is a cross-sectional view taken along the line 13B-13B in FIG. 13A. FIG. 14A is a top view and FIG. 14B is a cross-sectional view taken along the line 14B-14B in FIG. 14A. FIG. 15A is a top view and FIG. 15B is a cross-sectional view taken along the line 15B-15B in FIG. 15A. FIG. 16 shows a cross-sectional view corresponding to the cross-sectional view of FIG. 12.

In the second embodiment, the bottom part 111 of the magnetic base body 11 has a first oval protrusion 111b and a second oval protrusion 111bb. The first oval protrusion 111b protrudes upward from the bottom plate 111a outside the winding part 14a, and the second oval protrusion 111bb protrudes upward from the bottom plate 111a inside the winding part 14a. The first oval protrusion 111b has the thickness d1 and the second oval protrusion 111bb has a thickness d11. The thickness d1 may be equal to the thickness d11. The thickness d1 (d11) is, for example, less than three times the second particle diameter, and each of the two oval protrusions 111b and 111bb serves as the first magnetic portion 11a. In the second embodiment, therefore, the first magnetic portion 11a is provided both outside and inside the winding part 14a of the conductor 14. The height of the inner oval protrusion 111bb may be the same as the height of the outer oval protrusion 111b.

In the second embodiment, the conductor 14 is placed so that the winding part 14a fits between the outer oval protrusion 111b and the inner oval protrusion 111bb of the molded bottom part 111, as shown in FIGS. 14A and 14B. Subsequently, as shown in FIGS. 15A and 15B, the top part 112 is molded on top of the bottom part 111 and the conductor 14 to obtain a compact 110 that is integrated with the conductor 14, and that becomes the magnetic base body 11. As in the first embodiment, the upper part 112 of the second embodiment has a top plate portion 112a, a core portion 112b, and an outer edge portion 112c. In the second embodiment, the core portion 112b is located inside the inner protrusion 111bb, which is located inward of the winding part 14a.

As in the first embodiment, the upper part 112 of the second embodiment has no upper limit on the thickness (thickness in the L-axis direction), and the upper part thickness, including the thinnest portion, is at least three times the second particle diameter. Therefore, the entire upper part 112 serves as the second magnetic portion 11b.

As in the first embodiment, the coil component 1 of the second embodiment is obtained by forming external electrodes 12 on the outer surface of the magnetic base body 11, which is molded together with the conductor 14, as shown in FIG. 16. As in the first embodiment, the coil component 1 of the second embodiment has high magnetic saturation properties and high inductance properties, and can achieve the downsizing while maintaining its performance as the coil component 1.

### Third Embodiment

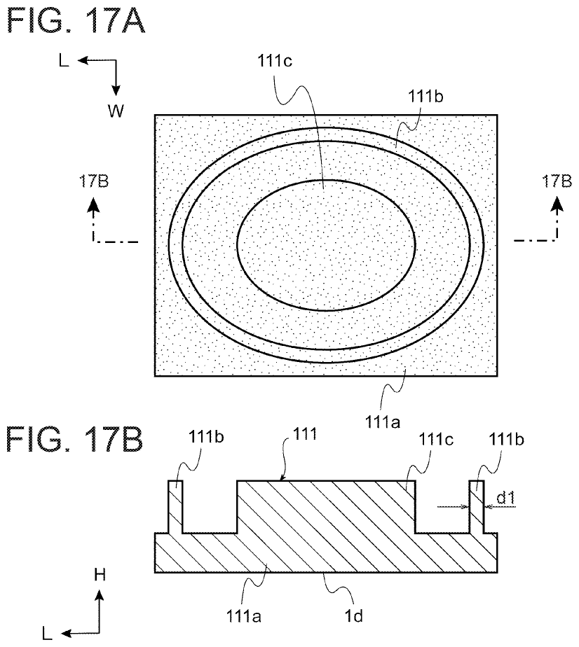

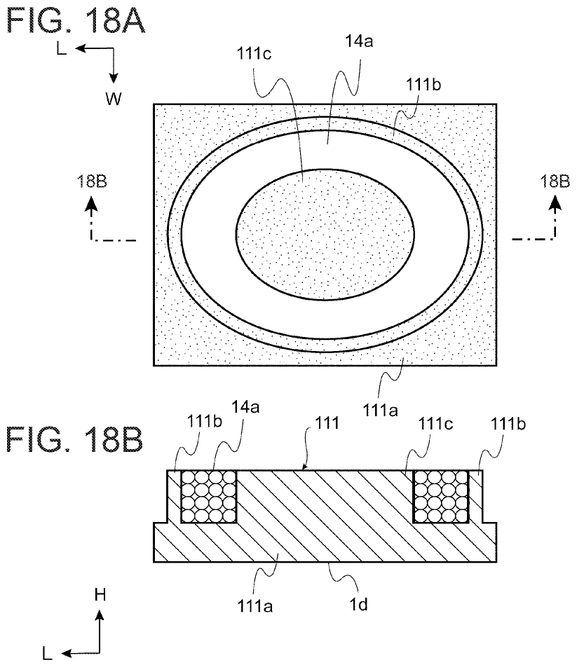

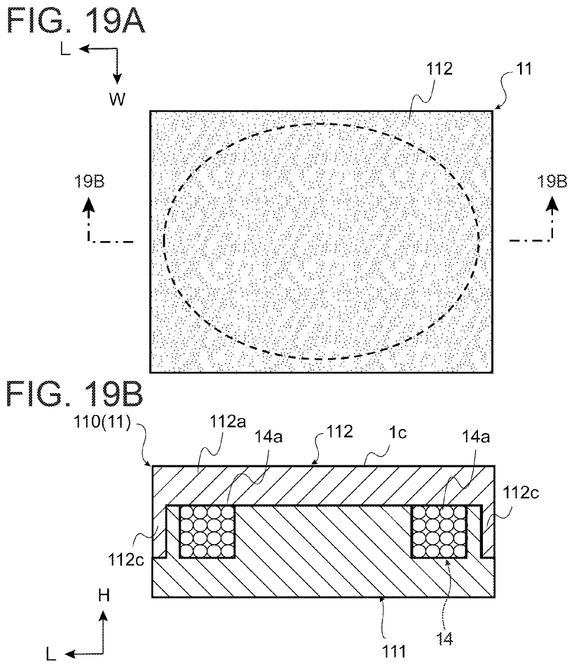

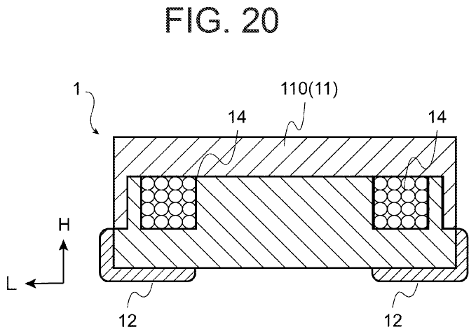

FIG. 17A through FIG. 20 show the manufacturing method of the coil component 1 in a third embodiment of the present invention. FIG. 17A is a top view and FIG. 17B is a cross-sectional view taken along the line 17B-17B in FIG. 17A. FIG. 18A is a top view and FIG. 18B is a cross-sectional view taken along the line 18B-18B in FIG. 18A. FIG. 19A is a top view and FIG. 19B is a cross-sectional view taken along the line 19B-19B in FIG. 19A. FIG. 20 shows a cross-sectional view corresponding to the cross-sectional view of FIG. 12. Similar reference numerals are used to designate similar items in the first and third embodiments.

In the third embodiment, the bottom part 111 of the magnetic base body 11 has an oval protrusion 111b and another protrusion 111c. The oval protrusion 111b protrudes upward from the bottom plate 111a outside the winding part 14a. The second protrusion 111c may be referred to as a core portion (center protrusion), and protrudes upward from the bottom plate 111a inside the winding part 14a. In the third embodiment, the thickness d1 of the protruding 111b is less than three times thicker than the second particle diameter, for example, and the protrusion 111b serves the first magnetic portion 11a. The core portion 111c serves as the second magnetic portion 11b.

In the third embodiment, the conductor 14 is placed so that the winding part 14a fits between the outer protrusion 111b and the inner protrusion (core portion) 111c of the molded bottom part 111, as shown in FIGS. 18A and 18B. Then, as shown in FIGS. 19A and 19B, the top part 112 is molded over the bottom part 111 and conductor 14 to obtain a compact 110 that is integral with the conductor 14. The compact 110 serves as the magnetic base body 11. The upper part 112 of the third embodiment has a top 112a and an outer edge 112c and has no core portion. As in the first embodiment, the upper part 112 of the third embodiment has no upper limit on the thickness (thickness in the L-axis direction), and its thickness, including the thinnest portion, is at least three times the second particle diameter. Therefore, the entire upper part 112 serves as the second magnetic portion 11b.

As in the first embodiment, the coil component 1 of the third embodiment is obtained by forming the external electrodes 12 on the outer surface of the magnetic base body 11, which is molded together with the conductor 14, as shown in FIG. 20. As in the first embodiment, the coil component 1 of the third embodiment has high magnetic saturation properties and high inductance properties, and can achieve downsizing while maintaining its performance as the coil component 1.

### Fourth Embodiment

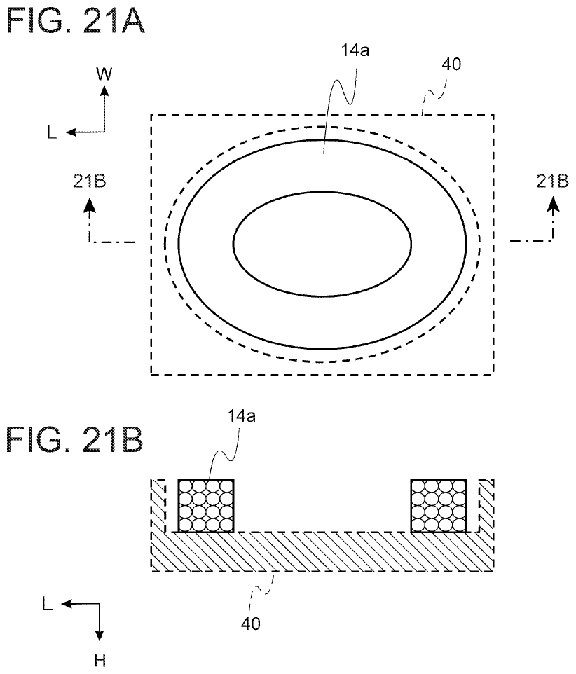

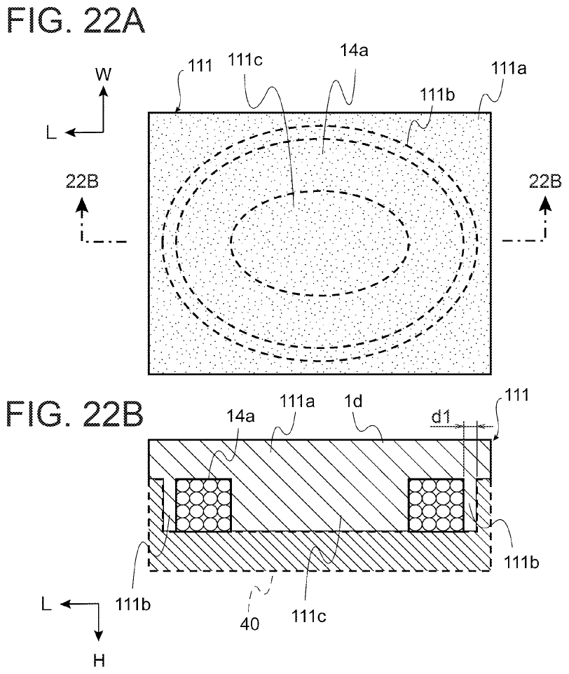

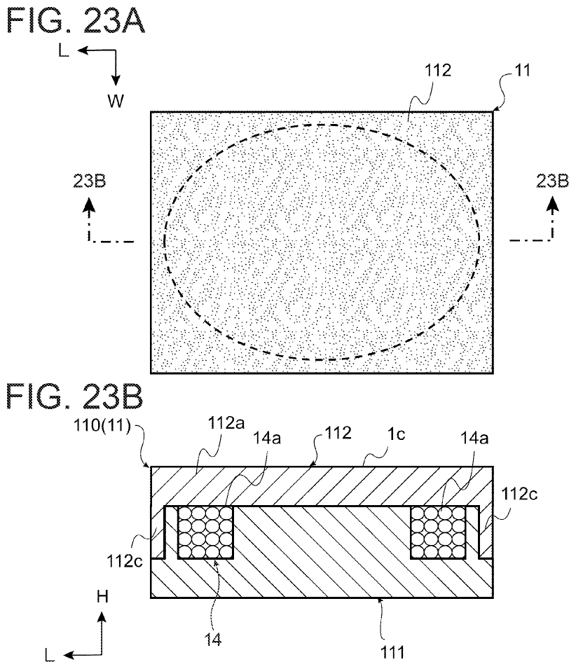

FIG. 21A to FIG. 23B show the manufacturing process of the coil component 1 in a fourth embodiment of the present invention. FIG. 21A is a top view and FIG. 21B is a cross-sectional view taken along the line 21B-21B in FIG. 21A. FIG. 22A is a top view and FIG. 22B is a cross-sectional view taken along the line 22B-22B in FIG. 22A. FIG. 23A is a top view and FIG. 23B is a cross-sectional view taken along the line 23B-23B in FIG. 23A. Similar reference numerals are used to designate similar items in the first, third and fourth embodiments.

In the fourth embodiment, a coil component that has the same structure as that of the coil component of the third embodiment is manufactured by a manufacturing method different from the manufacturing method of the third embodiment.

In the fourth embodiment, as shown in FIG. 21A and FIG. 21B, a mold 40 for making the bottom part 111 is prepared and the conductor 14 is placed in the mold 40. Then, as shown in FIGS. 22A and 22B, the bottom part 111 is molded such that the bottom part 111 has a bottom plate portion 111a, a protruding portion 111b, and a core portion 111c. In this molding process, the thickness d1 of the protruding portion 111b is set by the gap between the mold 40 and the winding part 14a. It should be noted that the bottom part 111 is shown in an inverted state in FIG. 22B, with the bottom face 1d facing up.

In the fourth embodiment, the bottom part 111 is molded while the conductor 14 is in the mold 40, so the bottom part 111 and conductor 14 are more integrated than in the third embodiment. The compact in which the bottom part 111 and conductor 14 are integrated is removed from the mold 40 and flipped vertically.

Then, as shown in FIGS. 23A and 23B, the top part 112 is molded over the compact in which the bottom part 111 and conductor 14 are integrated. The top part 112 of the fourth embodiment is similar to that of the third embodiment, and the top part 122 of the fourth embodiment is molded in the same manner as in the third embodiment to obtain a compact 110 that is integrated with the conductor 14. The compact 10 serves as the magnetic base body 11. As in the third embodiment (FIG. 20), the external electrodes 12 are formed to obtain the coil component 1 of the fourth embodiment.

The manufacturing method in the fourth embodiment can also produce the coil component 1 with the same structure as the third embodiment. The conductor 14 and the magnetic base body 11 are more integrated in the fourth embodiment than in the third embodiment.

### Fifth Embodiment

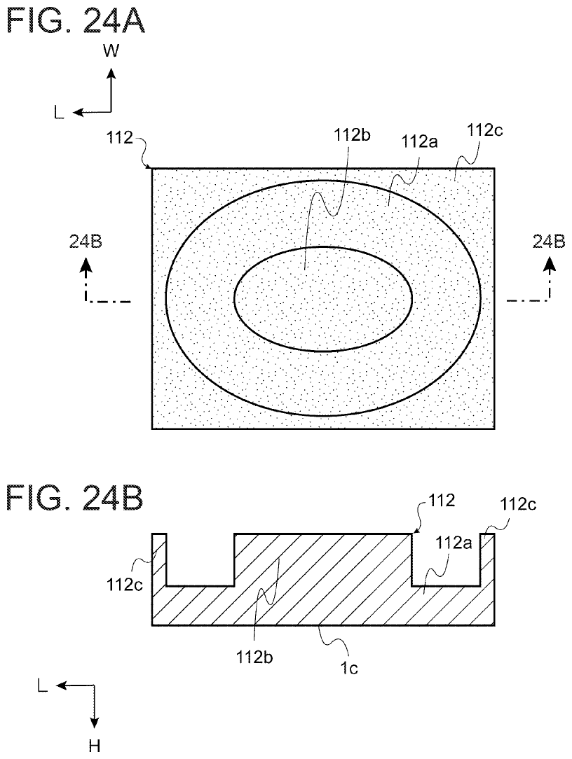

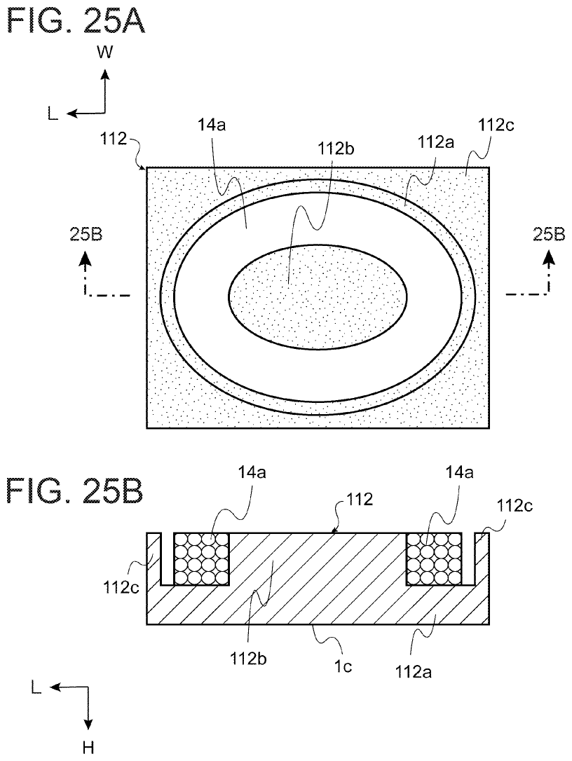

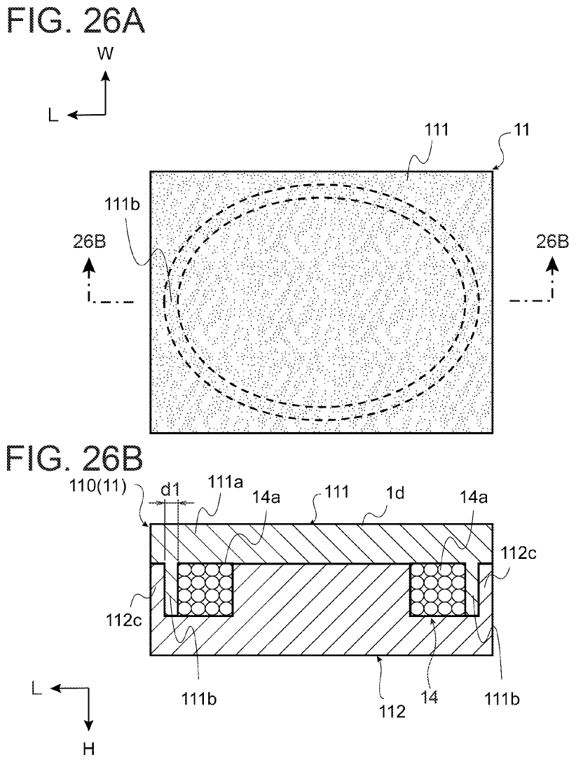

FIG. 24A through FIG. 26 show the manufacturing method of the coil component 1 in a fifth embodiment of the present invention. FIG. 24A is a top view and FIG. 24B is a cross-sectional view taken along the line 24B-24B in FIG. 24A. FIG. 25A is a top view and FIG. 25B is a cross-sectional view taken along the line 25B-25B in FIG. 25A. FIG. 26A is a top view and FIG. 26B is a cross-sectional view taken along the line 26B-26B in FIG. 26A.

In the fourth embodiment, a coil component 1 that has the same structure as the first embodiment is manufactured by a manufacturing method different from the manufacturing method of the first embodiment. Similar reference numerals are used to designate similar items in the first and fifth embodiments.

In the fifth embodiment, the upper part 112 is molded first, as shown in FIG. 24. The upper part 112 is formed, for example, by filling the mold, which corresponds to the shape of the upper plate 112a, core 112b and outer edge 112c, with the composite material. It should be noted that the upper part 112 is illustrated in FIG. 24B in an upside-down state with the top face 1c facing down.

In the fifth embodiment, the conductor 14 is placed in the molded upper part 112 as shown in FIGS. 25A and 25B. That is, the core 112b of the upper part 112 fits in the winding part 14a of the conductor 14 such that the conductor 14 is received in the upper part 112. Then, as shown in FIGS. 26A and 26B, the bottom part 111 is molded over the top part 112 and conductor 14 to obtain a compact 110 that is integral with the conductor 14. The compact 110 serves as the magnetic base body 11. The thickness d1 of the protruding portion 111b in the fifth embodiment is set by the gap between the outer edge 112c of the top part 112 and the winding part 14a of the conductor 14. As in the first embodiment (FIG. 12), the external electrodes 12 are formed, to obtain the coil component 1 of the fifth embodiment.

The manufacturing method in the fifth embodiment can also produce a coil component 1 with a structure similar to that of the first embodiment. According to the manufacturing method in the fifth embodiment, the protruding portion 111b, which becomes the first magnetic portion 11a, has high adhesion to the winding part 14a of the conductor 14, and therefore the magnetic properties of the coil component 1 are stable.

### Sixth Embodiment

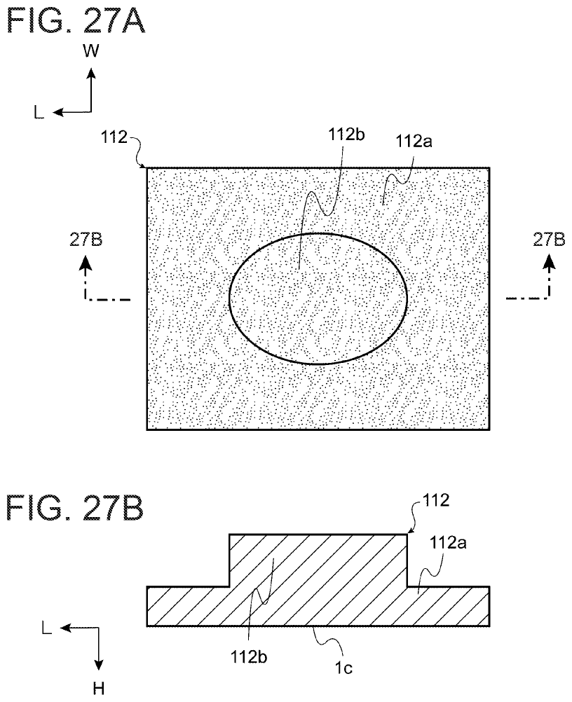

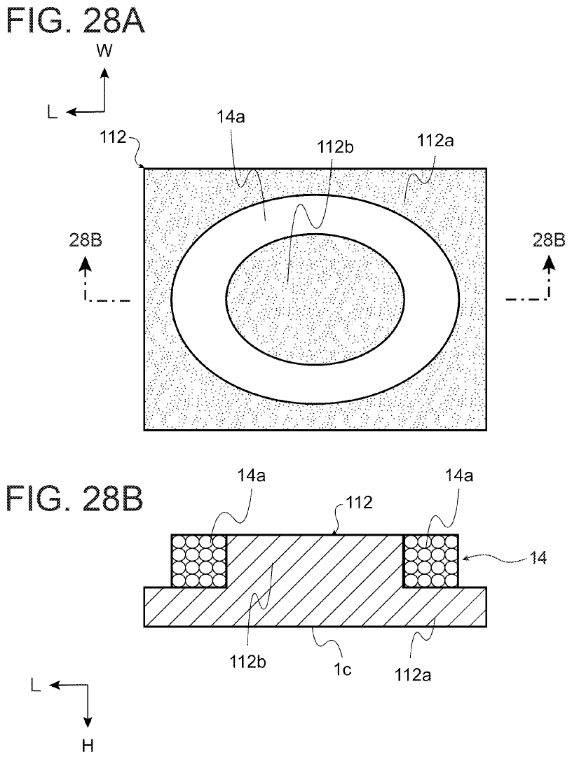

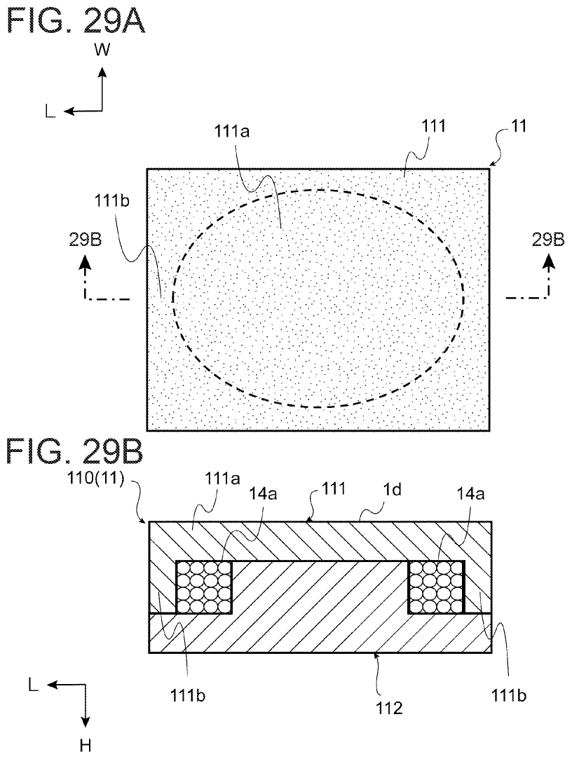

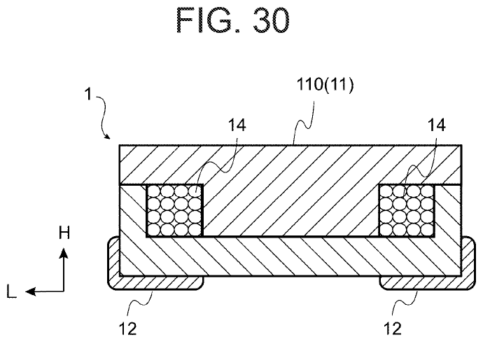

FIG. 27A through FIG. 30 show the manufacturing method of the coil component 1 in a sixth embodiment of the present invention. FIG. 27A is a top view and FIG. 27B is a cross-sectional view taken along the line 27B-27B in FIG. 27A. FIG. 28A is a top view and FIG. 28B is a cross-sectional view taken along the line 28B-28B in FIG. 28A. FIG. 29A is a top view and FIG. 29B is a cross-sectional view taken along the line 29B-29B in FIG. 29A. FIG. 30 is a cross-sectional view corresponding to the cross-sectional view of FIG. 12. Similar reference numerals are used to designate similar items in the first and sixth embodiments.

In the sixth embodiment, the upper part 112 is molded first, as shown in FIGS. 27A and 27B. The upper part 112 in the sixth embodiment has an upper plate 112a and a core (center protrusion) 112b. The conductor 14 is placed over the molded upper part 112 as shown in FIGS. 28A and 28B. That is, the conductor 14 is engaged with the upper part 112 such that the winding part 14a of the conductor 14 fits over the core portion 112b of the upper part 112, and the conductor 14 is placed on the upper part 112.

In the sixth embodiment, as shown in FIGS. 29A and 29B, the bottom part 111 is molded on top of the top part 112 on which the conductor 14 is placed, resulting in a compact 110 that is integrated with the conductor 14, and that becomes the magnetic base body 11. In the sixth embodiment, the top part 112 is formed of the second composite material and the bottom part 111 is formed of the first composite material. As a result, the entire bottom part 111 becomes the first magnetic portion 11a, and the entire portion around the winding part 14a becomes the first magnetic portion 11a. Thus, the coil component 1 of the sixth embodiment has high magnetic saturation properties.

As in the first embodiment, the coil component 1 of the sixth embodiment is obtained by forming the external electrodes 12 on the outer surface of the magnetic base body 11, which is molded together with the conductor 14, as shown in FIG. 30.

### Seventh Embodiment

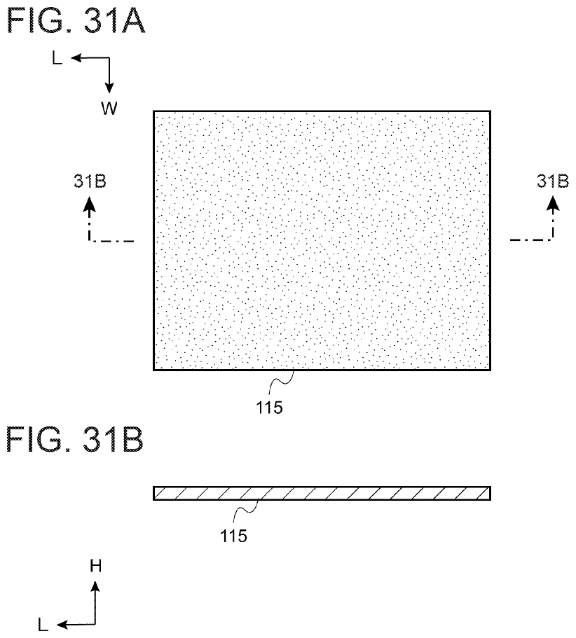

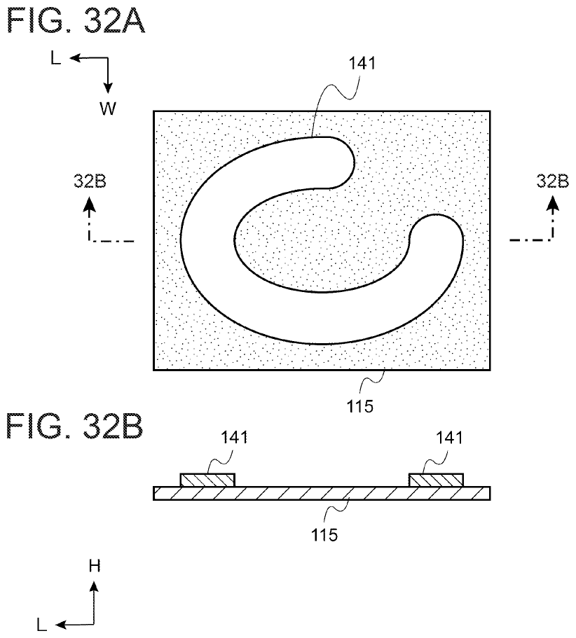

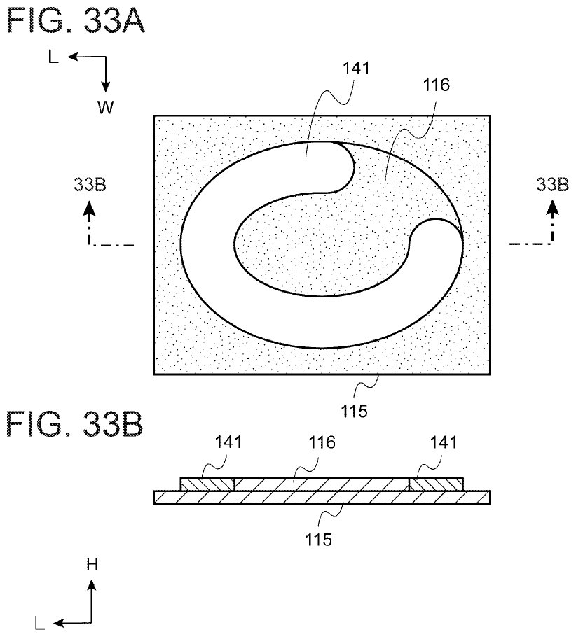

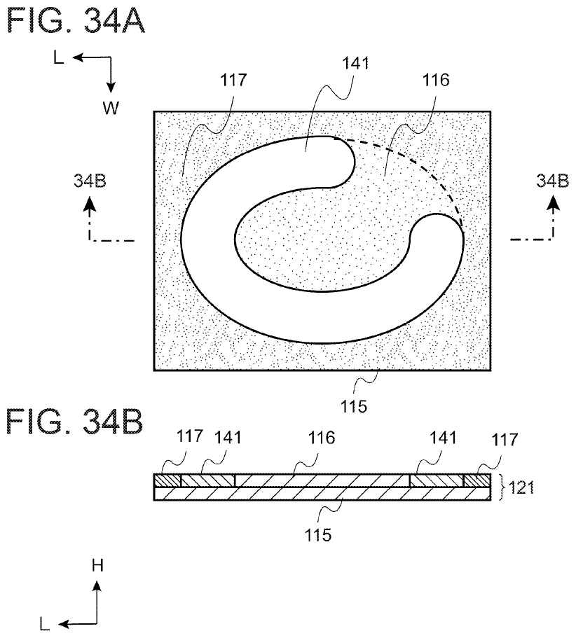

FIG. 31A through FIG. 37 show the manufacturing method of the coil component 1 in a seventh embodiment of the present invention. FIG. 31A is a top view and FIG. 31B is a cross-sectional view taken along the line 31B-31B in FIG. 31A. FIG. 32A is a top view and FIG. 32B is a cross-sectional view taken along the line 32B-32B in FIG. 32A. FIG. 33A is a top view and FIG. 33B is a cross-sectional view taken along the line 33B-33B in FIG. 33A. FIG. 34A is a top view and FIG. 34B is a cross-sectional view taken along the line 34B-34B in FIG. 34A. Similar reference numerals are used to designate similar items in the first and seventh embodiments.

In the seventh embodiment, the conductor 14 and magnetic base body 11 are formed by a stacking method. For example, as shown in FIGS. 31A and 31B, a magnetic sheet 115 made of the second composite material is prepared first. Then, as shown in FIGS. 32A and 32B, a planar conductor pattern 141 is formed on the surface of the magnetic sheet 115 by, for example, printing (screen printing, inkjet printing, gravure printing). Methods other than printing, such as plating, vapor deposition, paste transfer, etc., may be used to form the conductor pattern 141. The conductor pattern 141 will ultimately become the conductor 14. A plurality of magnetic sheets 115 having the conductor patterns 141 thereon are prepared.

Holes (not shown) are drilled in each of the magnetic sheets 115 for the formation of connecting conductors that connect the conductor patterns 141 between the magnetic sheets 115, and the holes are filled with conductive material. The connecting conductors are made, for example, by printing and filling. The printing of the connecting conductor may be done simultaneously with the printing of the conductor pattern 141 or separately. Techniques other than printing, such as plating, vapor deposition, paste transfer, etc., may also be used to form the connecting conductor.

Subsequently, as shown in FIGS. 33A and 33B, an area defined by the conductor pattern 141 on each of the magnetic sheets 115 (inner area of the conductor pattern 141) is filled with the second composite material to form the core portion 116. A combination of the conductor pattern 141 and the core portion 116 has a generally oval shape when viewed from the top, as shown in FIG. 33A. As shown in FIGS. 34A and 34B, an area around the conductor pattern 141 (outer area of the conductor pattern 141) is filled with the first composite material to form the outer edge 117. Thus, in the seventh embodiment, the magnetic sheet 115 and the core portion 116 become the second magnetic portion 11b, and the outer edge portion 117 becomes the first magnetic portion 11a.

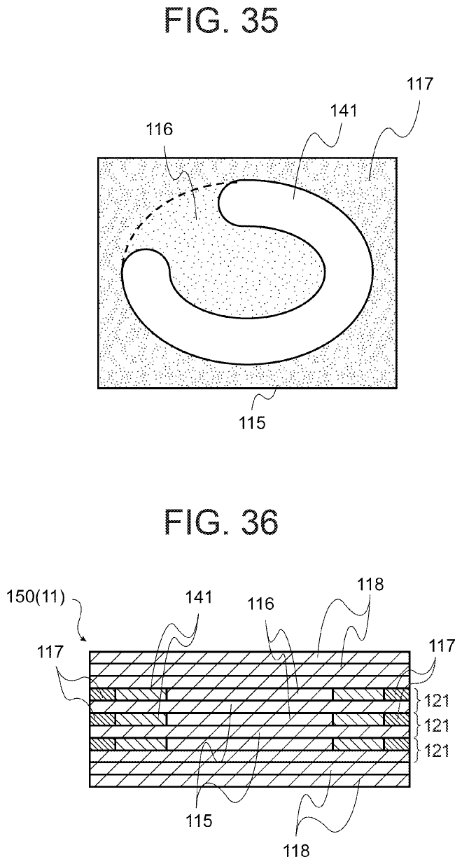

As shown in FIG. 34B, a two-layer structure 121 is prepared by the process of FIG. 31A to FIG. 34B. A plurality of two-layer structures 121 are prepared by repeating the process of FIG. 31A to FIG. 34B. It should be noted, however, that the shapes (e.g., locations of discontinued parts) of the conductor patterns 141 on the magnetic sheets 115 in the respective two-layer structures 121 are different from each other (although the shapes have overlapping portions as viewed in an axial direction). As shown in FIG. 35, for example, the shape of the conductor pattern 141 of FIG. 35 is different from that of FIG. 34A. The shapes of the conductor patterns 141 in the respective layers are different so that the conductor patterns 141 are connected in a spiral shape when the layers are stacked in the H-axis direction, as shown in FIG. 36. In FIG. 36, the two-layer structures 121 are stacked, and additional magnetic sheets 118 are placed on the top and the bottom of the stack of the two-layer structures 121. The top magnetic sheets 118, the stack of the two-layer structures 121, and the bottom magnetic sheets 118 are pressed in the H-axis direction to obtain a laminate 150. In the laminate 150, the conductor patterns 141 are connected in a spiral shape to become the conductor 14.

Heat treatment is then performed on the laminate 150 to obtain the magnetic base body 11 that has the built-in conductor 14. The heat treatment of the laminate 150 may be performed at 600-850 degrees C. such that the resin may be removed by thermal decomposition and an oxide may be provided on the surface of the metallic magnetic particles.

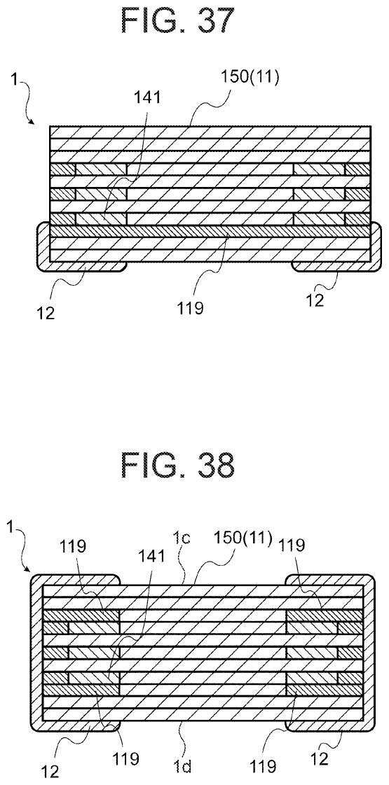

Thereafter, as shown in FIG. 37, the external electrodes 12 that connect to the conductor 14 are formed on the outer surface of the laminate 150 (magnetic base body 11) to obtain the coil component 1. Preferably, the laminate 150 (magnetic base body 11) is provided with a magnetic layer 119 between the conductor pattern 141 (conductor 14) and the external electrodes 12. The magnetic layer 119 is made of the first composite material. The magnetic layer 119 becomes the first magnetic portion 11a and contributes to enhancing the insulation between the conductor pattern 141 and the external electrode 12.

FIG. 38 shows a modification to the external electrodes 12.

The external electrodes 12 formed on the outer surface of the laminate 150 (magnetic base body 11) may extend onto the top surface 1c and/or bottom surface 1d of the laminate 150. When the external electrodes 12 extend onto the top surface 1c and bottom surface 1d, as shown in FIG. 38, it is preferred that a magnetic layer 119 made of the first composite material is provided on (or above) the conductor pattern 141 (conductor 14) and another magnetic layer 119 made of the first composite material is provided below the conductor pattern 141.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed:

1. A coil component comprising:
a winding part that is constituted by a wound conductor; and
a magnetic base body that includes a first magnetic portion and a second magnetic portion, all metallic particles bonded together and included in the first magnetic portion being first metallic particles, an average particle diameter of the first metallic particles being a first particle diameter, all metallic particles bonded together and included in the second magnetic portion being second metallic particles, an average particle diameter of the second metallic particles being a second particle diameter, the magnetic base body being configured to encapsulate the winding part, the second particle diameter being larger than the first particle diameter, and at least a portion of the first magnetic portion being provided outward of an outer circumference of the winding part.

2. The coil component according to claim 1, wherein the first magnetic portion is provided immediately adjacent to the outer circumference of the winding part.

3. The coil component according to claim 1, wherein the first magnetic portion is provided along an entire outer circumference of the winding part.

4. The coil component according to claim 1, wherein the first magnetic portion occupies at least a half of a volume of the magnetic base body outward of the winding part as viewed from a height direction of the coil component.

5. The coil component according to claim 1, further comprising an external electrode, wherein the first magnetic portion is provided between the winding part and the external electrode.

6. The coil component according to claim 1, wherein an external shape of the coil component is rectangular parallelepiped, and a long side of the external shape is 1.0 mm or less.

7. The coil component according to claim 1, wherein an external shape of the coil component is square or rectangular when viewed from a height direction of the coil component, and a height dimension of the external shape is smaller than one side of the square or rectangle.

8. A circuit board arrangement comprising:
a coil component recited in claim 1; and
a board on which the coil component is mounted.

9. An electronic device comprising the circuit board arrangement according to claim 8.

10. A method of manufacturing a coil component recited in claim 1, the method comprising, in any order:
forming a compact of a first magnetic portion;
forming a compact of a second magnetic portion; and
making a magnetic base body such that a winding part that has a wound conductor is encapsulated by the compact of the first magnetic portion and the compact of the second magnetic portion.

11. The method according to claim 10, wherein a portion of the magnetic base body outward of an outer circumference of the winding part is formed of one kind of material.

12. The method according to claim 10, wherein a binder that binds the first metal particles together and a binder that binds the second metal particles together are of the same composition.

13. The method according to claim 12, wherein bonding the first metal particles together in the first magnetic portion and bonding the second metal particles together in the second magnetic portion are performed in a same process.
